(19) United States
(12) Patent Application Publication
(10) Pub. No.: US 2015/0058726 A1
(43) Pub. Date: Feb. 26, 2015

(54) AUDIO MENU

(71) Applicant: CAROL CORCORAN, Solana Beach, CA (US)

(72) Inventor: CAROL CORCORAN, Solana Beach, CA (US)

(21) Appl. No.: 13/975,163

(22) Filed: Aug. 23, 2013

(51) Int. Cl. G06F 3/16

(52) U.S. Cl. CPC G06F 3/162
USPC 715/716

(57) ABSTRACT

An audio menu for allowing a user receive menu content at a merchant establishment audibly. The audio menu comprises a base housing having a speaker, a microphone, two volume control button, three playback control buttons, two language speed control buttons, two language selection buttons, and a base stand. The base housing also includes a controller, non-volatile memory, audio codecs, an analog to digital converter, a digital to analog converter, and a power source. A software component is stored on the memory and is used by the controller with electrical power supplied by the power supply to operate the interface components. The software component additionally provides for enhancing the user interface of the audio menu through the provision of voice recognition of the basic command provided for by each button on the base housing.

### BACKGROUND OF THE INVENTION

1. Field of the Invention

This invention relates generally to audio devices and, more particularly, to a audio menu device for the visually impaired.

2. Description of the Prior Art

The conveniences from a societal interaction standpoint of simply being able to understand written media commonly go unappreciated. One such convenience is simply reading a menu at a restaurant or other merchant establishments. For individuals who are visually impaired or individuals who do not speak the language native to their present location, simply ordering food at a restaurant can be a daunting task or can require substantial assistance from others. Such can also apply to those who are learning disabled or to young readers. While some restaurants in common tourist venues offer menus with content in several languages or offer a plurality of menu options in different languages, the necessity to be able to see and read the text still remains. Thus, a problem which still exists is that visually impaired individuals or non-speakers of a language are presented with great difficulty in ordering food or otherwise purchasing goods and services at merchant establishments. If one cannot understand the offerings printed on menus or signage of the establishment, the simple act of ordering may not be ascertainable. Thus, there remains a need for an audio menu adapted to play the menu options of a merchant establishment audibly. It would be helpful if such an audio menu allowed such menu options to be selectively played in one of a plurality of languages. It would be additionally desirable for such an audio menu to include a voice recognition component for basic user input commands

The Applicant's invention described herein provides for an audio playback device adapted to audibly read the menu options at a specified merchant establishment, such as a restaurant. The primary components of Applicant's audio menu are a menu base, an audio output, an audio input, user actuators, and software component. When in operation, the audio menu allows a user to listen to the menu options at a merchant establishment and control the nature of the audio output heard. As a result, many of the limitations imposed by existing menus are removed.

### SUMMARY OF THE INVENTION

An audio menu for allowing a user receive menu content at a merchant establishment audibly. The audio menu comprises a base housing having a speaker, a microphone, two volume control button, three playback control buttons, two language speed control buttons, two language selection buttons, and a base stand. The base housing also includes a controller, non-volatile memory, audio codecs, an analog to digital converter, a digital to analog converter, and a power source. The base housing thus provides a housing means for containing connected components and providing an interface. A software component is used by the controller with electrical power supplied by the power supply to operate the interface components. It is stored on the memory and additionally provides for enhancing the user interface of the audio menu through the provision of voice recognition of the basic command provided for by each button on the base housing. As such, it provides a software means for controlling components and configuring the audio menu to selectively playback the menu options at a specified merchant establishment audibly.

It is an object of this invention to provide an audio menu adapted to play the menu options of a merchant establishment audibly.

It is another object of this invention to provide an audio menu allowing menu options to be selectively played in one of a plurality of languages.

It is yet another object of this invention to provide an audio menu which includes a voice recognition component for basic user input commands

These and other objects will be apparent to one of skill in the art.

### BRIEF DESCRIPTION OF THE DRAWINGS

FIG. 1 is a front perspective view of an audio menu built in accordance with the present invention having its stand extended.

FIG. 2 is a side elevational view of an audio menu built in accordance with the present invention having its stand withdrawn.

### DETAILED DESCRIPTION OF THE INVENTION

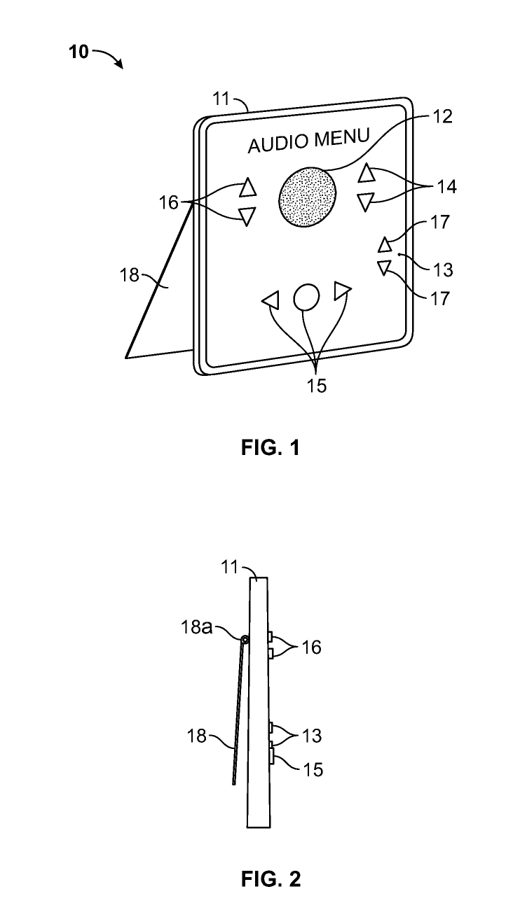

Referring now to the drawings and in particular FIGS. 1 and 2, the structure of an audio menu 10 is shown as a base housing 11 having interface components of defined as an audio output 12, an audio input 13, a plurality of user interface buttons 14, 15, 16, 17, and a base stand 18. The base housing 11 houses the audio menu's 10 interconnected electrical components, which include a controller, non-volatile memory, audio codecs, an analog to digital converter, a digital to analog converter, and a power source. A software component is stored on the memory and is used by the controller with electrical power supplied by the power supply to operate the interface components. The approximate dimensions of the base housing 10 are eight inches by five inches by one quarter inch. The user interface buttons 14, 15, 16, 17 are raised from the surface of the base housing so as to ease locating them by one who is visually impaired.

The audio output 12 is defined as a speaker which is adapted to play the audio which is generated by the electrical components. The audio output 12 is connected electrically to the digital to analog converter.

The audio input 13 is defined as a microphone which is adapted to receive audio which is present locally. The audio input 13 is connected electrically to the analog to digital converter and the controller so as to transmit signals carrying audio data to the electrical components.

The base housing 11 includes volume control buttons 14 which are connected electrically to the controller and used to cause the volume of audio played by the audio output 12 to increase or decrease. The top volume control button 14 is configured to raise the volume while the bottom volume control button 14 is configured to lower the volume.

The base housing 11 includes playback control buttons 15 which are connected electrically to the controller and used to control the playback of the audio played by the audio output 12. The left playback control button 15 is used to rewind, the middle playback control button 15 is used to play and pause audio playback of the menu content, and the right playback control button 15 is used to forward.

The base housing 11 includes volume control buttons 14 which are connected electrically to the controller and used to cause the volume of audio played by the audio output 12 to increase or decrease. The top volume control button 14 is configured to raise the volume while the bottom volume control button 14 is configured to lower the volume.

The base housing 11 includes language speed control buttons 16 which are connected electrically to the controller and used to cause the speed of the content being read in the audio playback to change. The top language speed control button 16 is configured to increase the playback speed while the language speed control button 16 is configured to decrease the playback speed.

The base housing 11 includes language selection buttons 17 which are connected electrically to the controller and used scroll through available languages to select the language of the content being read in the audio playback.

The base stand 18 is attached to back of the base housing 11 by way of a hinge pivot 18a. The hinge pivot allows the base stand to be set in and move between a first position adapted to allow the base housing 11 to stand substantially upright, as shown in FIG. 1, and a second position shown in FIG. 2.

In the preferred embodiment, the audio menu 10 is to be kept on location at a merchant establishment desiring to allow its menu to be heard by patrons. The content of the merchant's menu would be entered into and saved on the memory of the audio menu 10 in a plurality of languages. The software component is configured with instructions for the controller to operate the interface components and operate the electrical components, and it is additionally adapted to provide for enhancing the user interface of the audio menu 10 through the provision of voice recognition of the basic command provided for by each user interface button.

In an alternate embodiment of the present invention, software component is provided as a downloadable app and to be downloaded by a device and adapted to control the interface and electrical components of the device to which it was downloaded in a substantially identical manner as in the audio menu 10.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An audio menu, comprising:
a base housing having a plurality of interface components connected to a plurality of interconnected electrical components, wherein said interface components are defined as an audio output and at least one user interface button and the electrical components are defined as a controller, non-volatile memory, and a power source; and
a software component embedded on said non-volatile memory containing instructions which configure the audio menu to selectively playback the menu options at a specified merchant establishment audibly.

2. The audio menu of claim 1, wherein said electrical components additionally include audio codecs and a digital to analog converter.

3. The audio menu of claim 1, wherein:
said interface components additionally includes an audio input;
said electrical components additionally includes a digital to analog converter; and
said software component additional configures the audio menu to recognize voice commands and transmit instructions relating to said voice commands to the controller.

4. The audio menu of claim 3, wherein said interface components additionally includes at least one volume control button.

5. The audio menu of claim 4, wherein said software component additional configures the audio menu to recognize voice commands relating to audio playback volume and transmit instructions relating to said voice commands to the controller.

6. The audio menu of claim 3, wherein said interface components additionally includes at least one playback control button.

7. The audio menu of claim 6, wherein said software component additional configures the audio menu to recognize voice commands relating to playback control and transmit instructions relating to said voice commands to the controller.

8. The audio menu of claim 3, wherein said interface components additionally includes at least one language speed button.

9. The audio menu of claim 8, wherein said software component additional configures the audio menu to recognize voice commands relating to language speed playback and transmit instructions relating to said voice commands to the controller.

10. The audio menu of claim 3, wherein said interface components additionally includes at least one language selection button.

11. The audio menu of claim 10, wherein said software component additional configures the audio menu to recognize voice commands relating to playback language selection and transmit instructions relating to said voice commands to the controller.

12. The audio menu of claim 1, wherein said base housing includes a base stand attached to its surface.

13. The audio menu of claim 12, wherein said base stand is attached to said base housing by a hinge pivot allows the base stand to be set in and move between a first position adapted to allow the base housing to stand substantially upright and a second position wherein the stand is parallel and adjacent to the surface of the base housing.

14. An audio menu, comprising:
a housing means for containing connected components and providing an interface; and
a software means for controlling components and configuring the audio menu to selectively playback the menu options at a specified merchant establishment audibly.

15. An audio menu, comprising:
a base housing having a plurality of interface components connected to a plurality of interconnected electrical components and a base stand attached to its surface, wherein said interface components are defined as an audio output, an audio input, at least one volume control button, at least one playback control button, at least one language speed button, at least one language selection button and the electrical components are defined as a controller, non-volatile memory, audio codecs, a digital to analog converter, a digital to analog converter, and a power source; and
a software component embedded on said non-volatile memory containing instructions which configure the audio menu to selectively playback the menu options at a specified merchant establishment audibly, to recognize voice commands relating to the interface components and transmit instructions relating to said voice commands to the controller.

16. The audio menu of claim 15, wherein said interface components includes two volume control buttons.

17. The audio menu of claim 15, wherein said interface components includes three playback control buttons.

18. The audio menu of claim 15, wherein said interface components includes two language speed buttons.

19. The audio menu of claim 15, wherein said interface components includes two language selection buttons.

20. The audio menu of claim 15, wherein said base stand is attached to said base housing by a hinge pivot allows the base stand to be set in and move between a first position adapted to allow the base housing to stand substantially upright and a second position wherein the stand is parallel and adjacent to the surface of the base housing.
